(19) United States
(12) Patent Application Publication
(10) Pub. No.: US 2013/0152196 A1
(43) Pub. Date: Jun. 13, 2013

(54) THROTTLING OF ROGUE ENTITIES TO PUSH NOTIFICATION SERVERS

(71) Applicants: Neeraj Garg, Hyderabad (IN); Suvarna Singh, Hyderabad (IN); Rahul Thatte, Hyderabad (IN); Amrut Kale, Hyderabad (IN); Ashish Srivastava, Hyderabad (IN); Devi J V, Hyderabad (IN); Poornima Siddabattuni, Hyderabad (IN); Rajesh Peddibhotla, Hyderabad (IN); Sukumar Rayan, Hyderabad (IN); Aidan Downes, Seattle, WA (US); Deepak Rao, Bellevue, WA (US); Vadim Eydelman, Bellevue, WA (US); Bimal Mehta, Sammamish, WA (US)

(72) Inventors: Neeraj Garg, Hyderabad (IN); Suvarna Singh, Hyderabad (IN); Rahul Thatte, Hyderabad (IN); Amrut Kale, Hyderabad (IN); Ashish Srivastava, Hyderabad (IN); Devi J V, Hyderabad (IN); Poornima Siddabattuni, Hyderabad (IN); Rajesh Peddibhotla, Hyderabad (IN); Sukumar Rayan, Hyderabad (IN); Aidan Downes, Seattle, WA (US); Deepak Rao, Bellevue, WA (US); Vadim Eydelman, Bellevue, WA (US); Bimal Mehta, Sammamish, WA (US)

(73) Assignee: MICROSOFT CORPORATION, Redmond, WA (US)

(21) Appl. No.: 13/529,744

(22) Filed: Jun. 21, 2012

(30) Foreign Application Priority Data
Dec. 8, 2011 (IN) 3569/DEL/2011

(51) Int. Cl. G06F 21/00

(52) U.S. Cl. 726/22

(57) ABSTRACT

Techniques for throttling of rogue entities to push notification servers are described. An apparatus may comprise a processor and a memory communicatively coupled to the processor. The memory may store an application, the application maintaining a monitored domain table, the application maintaining an offending domain table, the application operative to receive an incoming request from a client in a domain, to detect harmful activity based on the request, and to respond to the harmful activity based on one or both of the monitored domain table and the offending domain table. Other embodiments are described and claimed.

### BACKGROUND

The increasing expectation of near-constant digital connectivity has led users to have an increasing desire for near-instant notification of relevant digital events. Push notifications, in which information is sent to a client device which “notifies” the user of the client device about a particular occurrence and/or condition, without the user having to specifically request the retrieval of the information, has become a popular method of providing this near-instant notification. However, the increasing use of push-notifications has led to increasing strain on the push-notification services, while decreasing user tolerance for errors and delays. Rogue entities may threaten the stability of push-notification services which increases the demand for techniques to limit their ability to cause such disruptions. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for the throttling of rogue entities to push notification servers. Some embodiments are particularly directed to techniques for the throttling of rogue entities to push notification servers wherein the client-access servers hosting the rogue entities are given a grace period to eliminate the rogue behavior. In one embodiment, for example, an apparatus may comprise a processor and a memory communicatively coupled to the processor, the memory to store an application, the application maintaining a monitored domain table, the application maintaining an offending domain table, the application operative to receive an incoming request from a client in a domain, to detect harmful activity based on the request, and to respond to the harmful activity based on one or both of the monitored domain table and offending domain table. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system for throttling of rogue entities to push notification servers.

FIG. 2 illustrates an embodiment of an operational environment for the system of FIG. 1.

FIG. 3 illustrates a first logic flow for the system of FIG. 1.

FIG. 4 illustrates a second logic flow for the system of FIG. 1.

FIG. 5 illustrates an embodiment of a centralized system for the system of FIG. 1.

FIG. 6 illustrates an embodiment of a distributed system for the system of FIG. 1.

FIG. 7 illustrates an embodiment of a computing architecture.

FIG. 8 illustrates an embodiment of a communications architecture.

### DETAILED DESCRIPTION

Various embodiments are generally directed to techniques for the throttling of rogue entities to push notification servers. A push notification refers to information that is sent to a client device and “notifies” a user of the client device about a particular occurrence and/or condition. An example of a push notification is a message delivered to a client device to inform a user that available information on a web service (e.g. news service, financial web service, etc.) has been updated. Other examples of push notifications include advertisements, emails or text messages, and similar types of announcements. Notifications may contain specific messages in themselves or they may act as notices that particular information is available elsewhere such as a web site.

A rogue entity may refer to a client of a push notification system whose behavior represents harmful activity to that system. A rogue entity may represent a client actively intended to cause harm to the system, to some aspect of the system, or to some other users of the system. A rogue entity may represent a client with no intent to cause harm, but whose behavior is nevertheless harmful. For example, a rogue entity may send push notifications which are improperly formatted, may send push notifications containing bad and/or harmful payloads, may attempt to overwhelm the system with excess messages, or may perform any client action with the effect of disrupting the push notification system. These actions may be the consequence of an individual or organized intent to harm the system or a user of the system, or may simply be the result of a poorly-programmed or malfunctioning client. In some situations, a push notifications service may be best aided by banning or blocking these rogue entities from accessing the system. However, because not all harmful activity may be intentional, completely blocking a rogue entity from accessing the system may be an over-reaction which degrades the experience of a user whose client or network connection has merely temporarily malfunctioned. As such, the push notification system may desire to throttle rogue entities to limit the harm they can cause, while still allowing an unintentional rogue entity limited access so as to not completely disconnect a well-intentioned user from the push notification service. It will be appreciated that immediacy expected of a push notification service increases both the inconvenience to a well-intentioned user who is blocked for a temporary technical fault and the disruption to the remaining users if a maliciously-intentioned user is allowed to disrupt service for an extended time. As a result, the embodiments can improve the scalability, reliability, and affordability of a push notification service while maintaining availability of the service to as wide an audience of users as possible.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

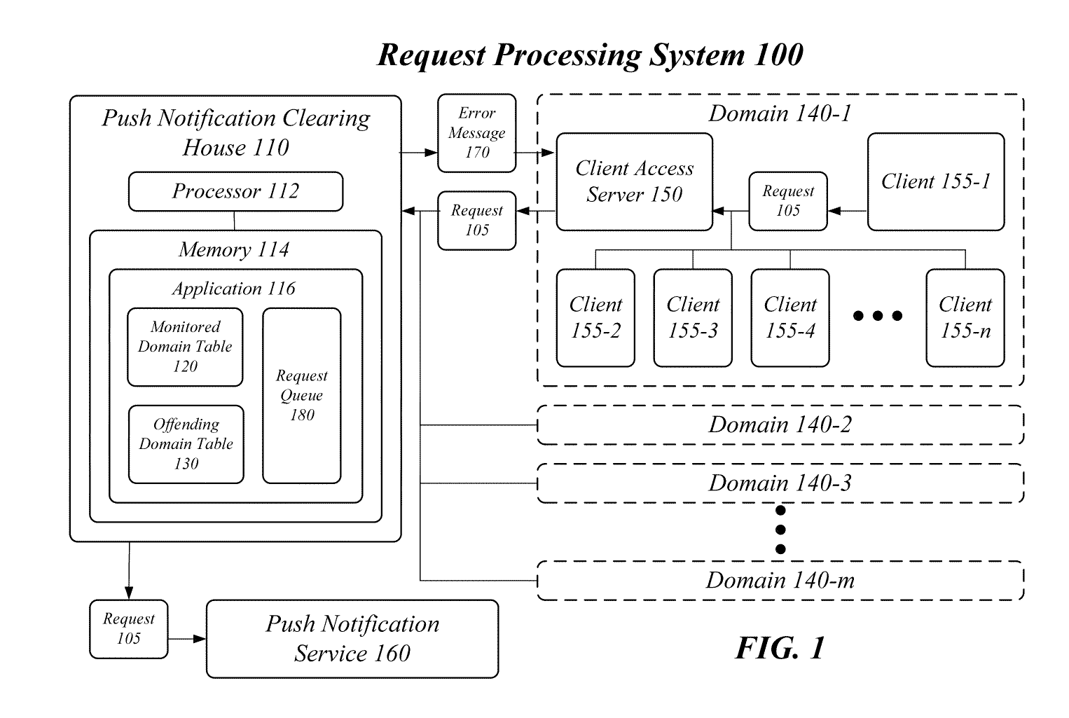

FIG. 1 illustrates a block diagram for a request processing system 100. In one embodiment, the request processing system 100 may comprise a computer-implemented request processing system 100 having a software application 116 stored in memory 114 and executing on processor 112. Although the request processing system 100 shown in FIG. 1 has a limited number of elements in a certain topology, it may be appreciated that the request processing system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 155-a may include components 155-1, 155-2, 155-3, 155-4 and 155-5. The embodiments are not limited in this context.

The request processing system 100 may comprise a push notification clearing house 110 with an application 116 stored in memory 114 capable of being executed on processor 112. In a typical usage scenario, the application 116 is arranged to receive requests from one or more clients from one or more domains 140-m. In some embodiments, the one or more clients in a domain may be managed and given access to the larger Internet by means of a client access server. For example, in FIG. 1 clients 155-n are managed by client access server 150. The client access servers, such as client access server 150, are generally operative to receive requests from the clients, ensure the validity of the requests, and then to forward valid requests to the push notification clearing house 110. For example, client access server 150 is operative to receive a request 105 from client 155-1, check it for validity, and upon finding it valid forward it to push notification clearing house 110. Push notification clearing house 110 is then operative to perform its own validity check and, upon finding the request 105 valid, forward it to the push notification service 160.

These sequential validity checks provide for tiered assurances of correctness, with the push notification clearing house 110, among other tasks, confirming the validity check performed by the client access server 150 for the domain 140-1. Particular clients 155-1 . . . 155-n and/or domains 110-1 . . . 110-n may be referred to herein to provide an exemplary process step or communication system. However, it should be understood that the descriptions herein are equally applicable to any of the domains 140-1 . . . 140-n and/or clients 155-1 . . . 155-n. From the perspective of the push notification clearing house 110, the client access server 150 is expected to not forward invalid messages or messages otherwise representing harmful activity. As such, from the perspective of the push notification clearing house 110, if client access server 150 forwards an invalid or otherwise harmful message, client access server 150 has failed in its responsibility to properly screen requests before forwarding them. In response, the push notification clearing house 110 may first attempt to warn the client access server 150 that it is allowing harmful requests to be forwarded. Then, if the client access server 150 doesn't reform its behavior in a reasonable amount of time (as set by a pre-defined grace period), the push notification clearing house 110 may begin to throttle access by client access server 150 to the push notification service 160 via push notification clearing house 110 and may raise an alert with administrators of the push notification clearing house 110 that the client access server 150 is failing to properly police the clients 155-n inside its domain 140-1.

The application 116 of push notification clearing house 110 may be generally arranged to maintain a monitored domain table 120 and to maintain an offending domain table 130. These tables may be stored according to any of the known techniques for storing a table, such as, without limitation, using an internal data structure or using an external database. Although push notification clearing house 110 is illustrated as a centralized system, it may also be configured as a distributed system where each system shares a common database or may be configured to maintain its own internal data structure. The offending domain table 130 may generally comprise a listing of domains wherein the corresponding client access servers have proven themselves as seriously failing to properly police the clients inside their domain. A domain 140-1 would be listed in the offending domain table 130 if the client access server 150 were to have allowed a sufficient quantity of requests representing harmful activity through over a sustained period of time. A client access server 150 is allowed both a predefined grace period and a predefined threshold of offending requests, wherein the domain 140-1 managed by the client access server 150 is placed on the offending domain table 130 if it has forwarded a quantity of offending requests through which at least meets the predefined threshold and has forwarded these offending requests over a period of time longer than the predefined grace period. A client access server 150 which has behaved in such a manner is considered to be offending—to have seriously failed in its responsibility to police the clients within its domain—and therefore represents a potential threat to the stability of the push notification clearing house 110 or the push notification service 160. As such, domains listed in the offending domain table 130 face restrictions on their access to the push notification clearing house 110 (and thereby restrictions on their access to the push notification service 160) so as to limit the extent of the damage they may cause to these systems. In some embodiments, a domain 140-1 being added to the offending domain table 130 will raise an alert for the administrators of the push notification clearing house 110. This may cause an increase in the restrictions placed on the offending domain 140-1 or may cause the removal of the offending domain 140-1 from the offending domain table 130, as determined by the administrators.

The monitored domain table 120 may generally comprise a listing of domains wherein the corresponding client access servers are failing to properly police the clients inside their domain, but where the failure to properly police has not become sufficiently extensive as to warrant throttling or other suppressive or punitive measures. From one perspective, the monitored domain table 120 contains those domains which are under observation as potentially needing to be placed on the offending domain table 130, but where their activity has not yet risen—has not exceeded the predefined threshold or persisted over a period of time longer than the grace period—to a level that warrants the punitive or suppressive measures imposed on domains identified on the offending domain table 130. A domain 140-1 would be listed in the monitored domain table 120 if the client access server 150 were to have allowed at least one request representing harmful activity through to the push notification clearing house 110, but its activity has not yet warranted placing the domain 140-1 on the offending domain table 130. In general, a domain 140-m will not appear on both the monitored domain table 120 and the offending domain table 130, nor will a domain 140-m be placed directly onto the offending domain table 130 without first undergoing a probationary period on the monitored domain table 120.

In various embodiments, the application 116 may be generally operative to receive an incoming request 105 from a client 155-n in a domain 140-m, to detect harmful activity based on the request 105, and to respond to the harmful activity based on one or both of the monitored domain table 120 and the offending domain table 130. Responding to the harmful activity based on these tables may generally correspond to managing the presence of the domain 140-1 on the monitored domain table 120 and the offending domain table 130 and managing what information is stored for the domain 140-1 on the monitored domain table 120 and the offending domain table 130.

In various embodiments, in response to the detection of the harmful activity, the application 116 may be generally operative to determine whether or not the domain 140-1 is identified in the monitored domain table 120 to add a domain entry for the domain 140-1 to the monitored domain table 120, and to send an error message 170 to the domain 140-1 communicating the detected harmful activity. The domain entry for the domain 140-1 in the monitored domain table 120 may comprise one or more of an identifier for the domain 140-1, a timestamp for the creation of the domain entry, a timestamp for the beginning of the grace period for the domain 140-1, a time at which the grace period for the domain 140-1 will end, a total offense count for the domain 140-1, and a listing of specific offenses. Each offense may comprise a sub-entry in the domain entry for the domain 140-1, wherein each sub-entry contains an identifier indicating the offense type, a count of the number of offenses of that type for the domain 140-1, a timestamp of the most recent offense of that type for the domain 140-1, and a listing of timestamps of all offenses of that type for the domain 140-1.

In some embodiments, specific offenses will not be counted in the monitored domain table 120 until after the expiration of the grace period, such that the initial offense which causes the creation of the domain entry in the monitored domain table 120 will not appear in the domain entry. In other embodiments, all offenses, including those which occur during the grace period, will be counted in the monitored domain table 120 such that the initial offenses which cause the creation of the domain entry in the monitored domain table 120 will appear in the domain entry as the first listed offense, starting with a count of “one.” In other embodiments, each offense—whether it occurs during the grace period or not—will be listed in the domain entry, but the total offense count for the domain 140-1 will not be increased above zero until the expiration of the grace period. In these embodiments, a full record and counting of offenses for each monitored domain will be maintained, but the domain 140-1 will not start to build up towards the threshold until the expiration of the grace period.

Sending an error message 170 to the domain 140-1 from push notification clearing house 110 may comprise using a known protocol to communicate with the client access server 150 managing the clients 155-n in the domain 140-1 to notify the client access server 150 that it forwarded a request 105 from one of its clients 155-1 which represents harmful activity. It is expected that the client access server 150 will take measures to prevent such harmful activity from being sent again, and as such the error message 170 represents a warning from the push notification clearing house 110 that the corresponding domain 140-1 has been added to the monitored domain table 120 and that with repeated offenses (e.g. beyond the threshold) over an extended duration (e.g. the grace period) the domain 140-1 may be added to the offending domain table 130 and subject to the consequences thereof (e.g. throttling).

In various embodiments, in response to the detection of the harmful activity, the application 116 may be generally operative to determine the domain 140-1 has a domain entry in the monitored domain table 120, to determine that a grace period is active for the domain 140-1, and to send error message 170 to the domain communicating the detected harmful activity. In some embodiments, the monitored domain table 120 may not be updated with the most recent offense so long as the grace period is active—in these embodiments, the threshold for moving the domain 140-1 from the monitored domain table 120 to the offending domain table 130 will only consider offenses which occur after the grace period has ended. In other embodiments, the monitored domain table 120 will be updated with the most recent offense whether or not the grace period is active. As previously discussed, this may include increasing the total offense count for the domain 140-1.

In response to the detection of the harmful activity, the application 116 may be generally operative to determine that the domain 140-1 has a domain entry in the monitored domain table 120, to determine that a grace period has expired for the domain 140-1, to increment an offense count for the domain entry in the monitored domain table 120, to determine that the offense count for the domain entry is under a threshold, and to send an error message 170 to the domain 140-1 communicating the detected harmful activity. The offense count may correspond to the total offense count entry for the domain entry for the domain 140-1. As previously discussed, in some embodiments this total offense account may include all offenses for the domain 140-1 or may only include those offenses committed since the expiration of the grace period.

In various embodiments, in response to the detection of the harmful activity, the application 116 may be generally operative to determine that the domain 140-1 has a domain entry in the monitored domain table 120, to determine that a grace period has expired for the domain 140-1, to increment an offense count for the domain entry in the monitored domain table 120, to determine that the incremented offense count for the domain entry is at least equal to a threshold, to remove the domain entry from the monitored domain table 120, to add an offending domain entry for the domain 140-1 to the offending domain table, and to send an error message 170 to the domain 140-1 communicating the detected harmful activity. As previously discussed, in some embodiments meeting this threshold may indicate that the total number of offenses for the domain 140-1 has met the threshold, or may indicate that the total number of offenses since the expiration of the grace period has met the threshold. In some embodiments, the error message 170 sent to the domain 140-1 may specifically communicate that the domain 140-1 has been added to the offending domain table 130 and that therefore the domain 140-1 will be subject to the associated consequence, such as throttling.

In various embodiments, in response to the domain 140-1 being added to the offending domain table 130, the application 116 may be operative to raise an alert 170 indicating that the domain 140-1 has been identified as an offending domain. This alert may be sent to the administrators of the push notification clearing house 110 to alert them that the client access server 150 is failing to properly police the clients 155-n inside its domain 140-1 and that the domain 140-1 has been added to the offending domain table 130 as a consequence.

The presence of a domain 140-1 on the offending domain table 130 will lead the push notification clearing house 110 to take actions to limit the harm that the offending domain 140-1 can cause to the push notification clearing house 110 and the push notification service 160. In some embodiments, this may comprise throttling the rate at which the domain 140-1—and thereby the client access server 150—can send requests through the push notification clearing house 110 to push notification service 160. This may be implemented using any of the known techniques for throttling a connection, such as by using a limited-length queue wherein requests are removed from the queue at an artificially-restrained rate and wherein requests are dropped if they are received while the queue is full.

It will be appreciated that as throttling limits the ability of the clients 155-n in the domain 140-1 to use the push notification clearing house 110 and thereby limits their ability to use the push notification service 160. If an offending domain 140-1 can be repaired or otherwise made to stop sending harmful requests, it may be removed from the offending domain table 130 and thereby stopping the throttling. This removal from the offending domain table 130 may be done as soon as possible, otherwise, users may experience degraded performance even after the domain 140-1 has been reformed. The alert sent to the administrators may therefore serve to promptly alert the administrators of the push notification clearing house 110 that a domain 140-1 needs to be evaluated as to whether it has been reformed and may be removed from the offending domain table 130 and therefore un-throttled.

Similarly, it will be appreciated that as throttling doesn't completely prevent the ability of clients 155-n in the domain 140-1 to cause harm to the push notification clearing house 110 and the push notification service 160 while requests are throttled, they're not completely blocked. As such, it may desirable for the administrators of the push notification clearing house 110 to block a domain whose harmful activity they judge to be sufficiently serious as to warrant blocking. The alert sent to the administrators may therefore serve to promptly alert the administrators of the push notification clearing house 110 that a domain 140-1 needs to be evaluated as to whether it represents a serious enough threat to be blocked. In various embodiments, harmful activity may comprise one or more of a request queue 180 for the application being full, the request being improperly formatted, the request having a bad payload, and the request having an invalid token.

In addition to one or more limited-length queues used in the performance of the throttling of domains 140-1 . . . 140-n in the offending domain table 130, the application 116 may maintain a request queue 180 to cope with, for example, bursts of received requests which exceed the ability of the push notification clearing house 110 to transmit requests to the push notification service 160. In general, the request queue 180 will not be artificially limited to throttle the domains 140-m or the push notification clearing house 110, except as may be required by the push notification service 160 as part of technical or service-level requirements. As such, the request queue 180 becoming full represents a larger number of requests being moved through the push notification clearing house 110 than intended or allowed. Therefore, a domain 140-1 which sends a request to a full request queue 180 becomes suspicious and therefore warrants being monitored or throttled as the full request queue 180 is intended to only occur if one or more domains are behaving improperly. The error message 170 sent to a domain 140-1 which has offended in this manner may communicate a “request queue full” message informing the client access server 150 that it needs to limit the number of requests it sends to the push notification clearing house 110 in order to assist in the clearing of the request queue 180. A client access server 150 which fails to do so is likely to repeatedly offend and thereby earn itself a place on the offending domain table.

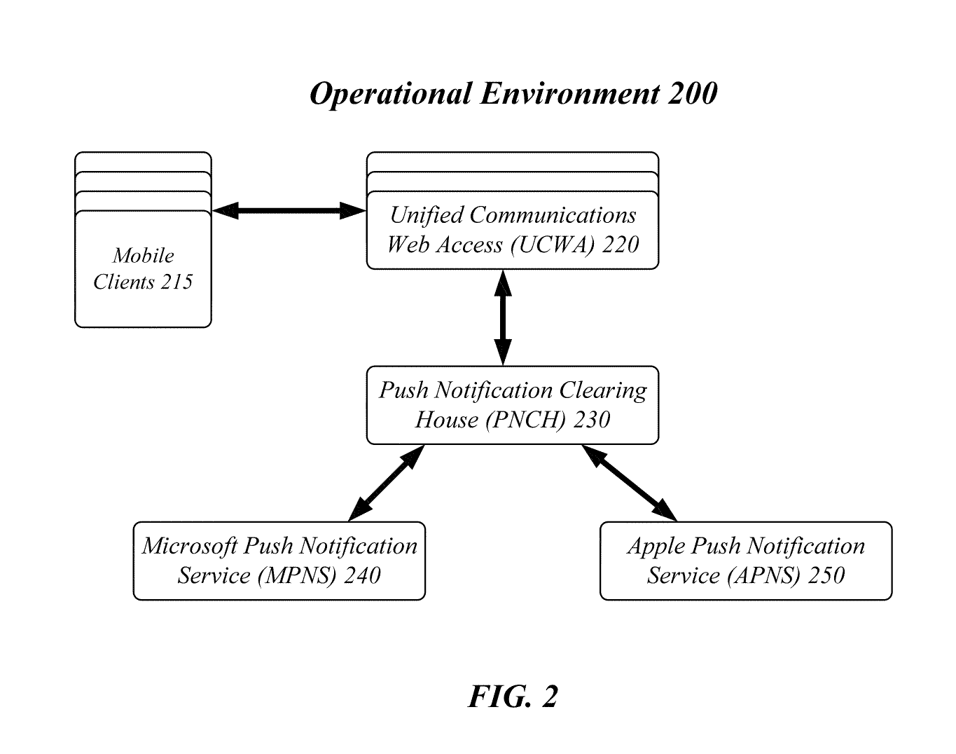

FIG. 2 illustrates an embodiment of an operational environment 200 for the request processing system 100. In general, and with reference to FIG. 1, the mobile clients 215 may correspond to clients within any of the domains 140-m, including without limitation the clients 155-n within domain 140-1. The Unified Communications Web Access (UCWA) 220 may correspond to a client access server such as client access server 150 which manages clients 155-n within domain 140-1. The Push Notification Clearing House (PNCH) component 230 may correspond to the push notification clearing house 110. The Microsoft Push Notification Service (MPNS) 240 and the Apple Push Notification Service (APNS) 250 may correspond to specific examples of the push notification service 160.

FIG. 2 generally illustrates an exemplary push notification architecture that employs a Push Notification Clearing House (PNCH) component 230 in accordance with the present invention. The PNCH component 230 enables push notification deliveries to mobile clients 215 (e.g. iPhone® and Microsoft® Windows® phone) of a distributed service such as, for example, Lync Server. The mobile clients 215 may communicate with a UCWA 230 (Unified Communications Web Access) via HTTP/HTTPS and the mobile clients 215 may subscribe to push notifications for particular events that a client is interested in. The UCWA 230 may send a push notification through PNCH component 230 which may act as a proxy for multiple push notification providers such as Microsoft Push Notification Service (MPNS) 240 and Apple Push Notification Service (APNS) 250. Each UCWA 220 communicates with the PNCH component 230 using, for example, SIP and authenticates with the distributed service, for example, Lync Server. The PNCH component 230 uses unique certificates to communicate with MPNS 240 and/or APNS 250. These certificates are based on application ids which the UCWA's 220 communicate to PNCH component 230 with every message. In this manner, PNCH component 230 may forward push notification requests to the appropriate push notification service (e.g. MPNS 240, APNS 250). The PNCH component 230 validates that the messages sent from a UCWA 220 to MPNS and/or APNS are in the proper format and may communicate with a particular push notification service based on a specific protocol. For example, MPNS 240 and APNS 250 may utilize different protocols as well as different message formats. PNCH component 230 serves as a proxy and forwards a request using the appropriate protocol and message format for a respective push notification service.

PNCH component 230 monitors the various UCWA's 220 to prevent a potentially offending domain from attacking a push notification service (e.g. MPNS 240, APNS 250). In other words, PNCH component 230 monitors the domains of UCWA 220 for activity that can potentially be considered harmful which may compromise the performance of MPNS 240 and/or APNS 250 as well as the operation of PNCH component 230. In addition, with identification of harmful activity, the push notification service (e.g. MPNS 240, APNS 250) may disconnect the existing connection with PNCH component 230. This necessitates setting up the connection again which negatively impacts performance of the PNCH component 230. Such an offending provider is referred to herein as a “Rogue UCWA.” Examples of such harmful activity include, but are not limited to, a bad payload, an invalid token, an unusable token, flooding and spamming. A bad payload activity refers to one or more UCWA's sending badly formed requests to PNCH component 230. An invalid token refers to an invalid device id where the device id has not been issued by the push notification service (MPNS 240, APNS 250) or has been cancelled. An unusable token refers to the situation when, for APNS 250, an application is uninstalled and for MPNS 240 it is when a device is out of network. Flooding refers to the condition where very high traffic to the PNCH component 230 exists beyond what it can handle. Spamming refers to the condition where push notification server users indicate that they are receiving push notifications that are not meant for them (i.e. junk messages). These messages may be considered valid, but are unsolicited and/or unwanted. These harmful activities may also be referred to as classes of errors and separate rules may apply for different classes of errors based on severity. The degree of severity of the class of error determines the grace period and allowed number of occurrences before a domain is blocked by the PNCH component 230. In addition, a Rogue UCWA may use PNCH component 230 to attack MPNS 240, APNS 250 which may result in PNCH component 230 getting blocked by MPNS 240 and/or APNS 250.

When PNCH component 230 detects the above referenced harmful activity, PNCH component 230 sends a notification to the offending UCWA 220 via a set of error codes corresponding to the identified activity. PNCH component 230 allows a grace period for the offending UCWA 220 to take corrective action as necessary to prevent the harmful activity. The grace period may also be used to take care of network latencies as well as avoiding timing issues. If the UCWA continues the harmful activity beyond the grace period and is not corrected, then the domain of the UCWA may be blocked. By monitoring the activity of UCWA's 220 using PNCH component 230 to send push notifications, PNCH component 230 may “throttle” requests from a UCWA 220. Moreover, monitoring and controlling Rogue UCWA's at run-time eliminates the need for a separate trust establishment process such as, for example, a provisioning web site.

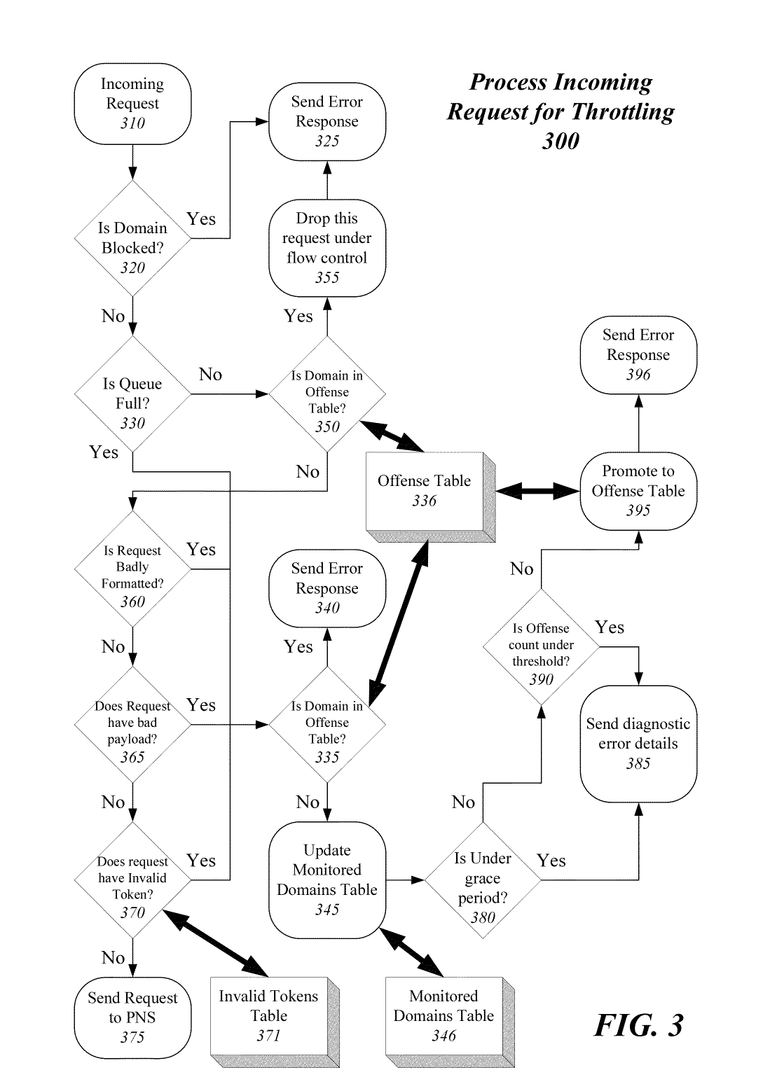

FIG. 3 illustrates one embodiment of a logic flow 300 for processing an incoming request for throttling utilizing PNCH component 230 shown in the system of FIG. 2. The logic flow 300 may be representative of some or all of the operations executed by one or more embodiments described herein.

In the illustrated embodiment shown in FIG. 3, an incoming request from a UCWA domain is received at block 310. A determination is made at block 320 whether the particular domain is blocked based on previous harmful activity. If the domain is blocked, then the logic flow proceeds to block 325 where a response is sent to the corresponding UCWA. This response is indicated as response 400 which may be a particular error code corresponding to an error message and/or process associated with one or more of the harmful activities noted above. If the UCWA domain is not blocked, the logic flow proceeds to block 330 where a determination is made as to whether or not the queue is full. If the queue is full which indicates flooding, the logic flow proceeds to block 335 where a check is performed to determine if the particular domain is identified in an offense table 336. The offense table 336 lists (e.g. offending domain table 130) domains that are attacking PNCH component 230. Under normal operating conditions, offense table 336 should be empty. However, once an offending domain is identified, it is entered into offense table 336. If the domain is identified in offense table 336, the logic flow proceeds to block 340 where a response or error message is sent.

If a determination is made at block 330 that the queue is not full, another determination is made at block 350 to see if the domain is identified on the offense table. If the domain is identified on the offense table, the logic flow proceeds to block 355 where the request is dropped and the response is sent at block 325. If the determination made at block 350 indicates that the domain is not identified in the offense table, then the logic flow proceeds to block 360 where a determination is made whether or not the request is badly formatted. If the request is badly formatted, then the logic flow proceeds to block 335 as described above. If the request is not badly formatted, then a determination is made at block 365 whether or not the request has a bad payload. If the request has a bad payload, then the logic flow proceeds to block 335 as described above. If the request does not have a bad payload, then the logic flow proceeds to block 370 where a determination is made as to whether the request has an invalid token. This determination is made by comparing the token associated with the request to the tokens identified in the invalid tokens table 371. The invalid tokens table contains the invalid tokens that the PNCH component 230 receives from the offending domains. If the request has an invalid token, then the logic flow proceeds to block 335 as described above. If the request does not have an invalid token, the logic flow proceeds to block 375 where the request is sent to the push notification service (PNS).

If the determination is made at block 330 that the queue is full, or that the request is badly formatted as determined at block 360, or that the request has a bad payload as determined at block 365, or that the request does not have an invalid token as determined at block 370, the logic flow 300 proceeds to block 335 where a determination is made whether the offending domain is identified in offense table 336. If the offending domain is not identified in the offense table, then the logic flow proceeds to block 345 where the monitored domains table 346 is updated. The logic flow proceeds to block 380 where a determination is made whether or not the offending domain is under a grace period. If the domain is under the grace period, then an error response is sent at block 385. If the offending domain is not under a grace period, then the logic flow proceeds to block 390 where a determination is made whether the offense count for a particular offending domain is under a predetermined threshold. If the offense count is under the predetermined threshold, then the logic flow returns to block 385 as described above. If the offense count is not under the predetermined threshold, then the offending domain is promoted to the offence table at block 395 and a response is sent at block 396.

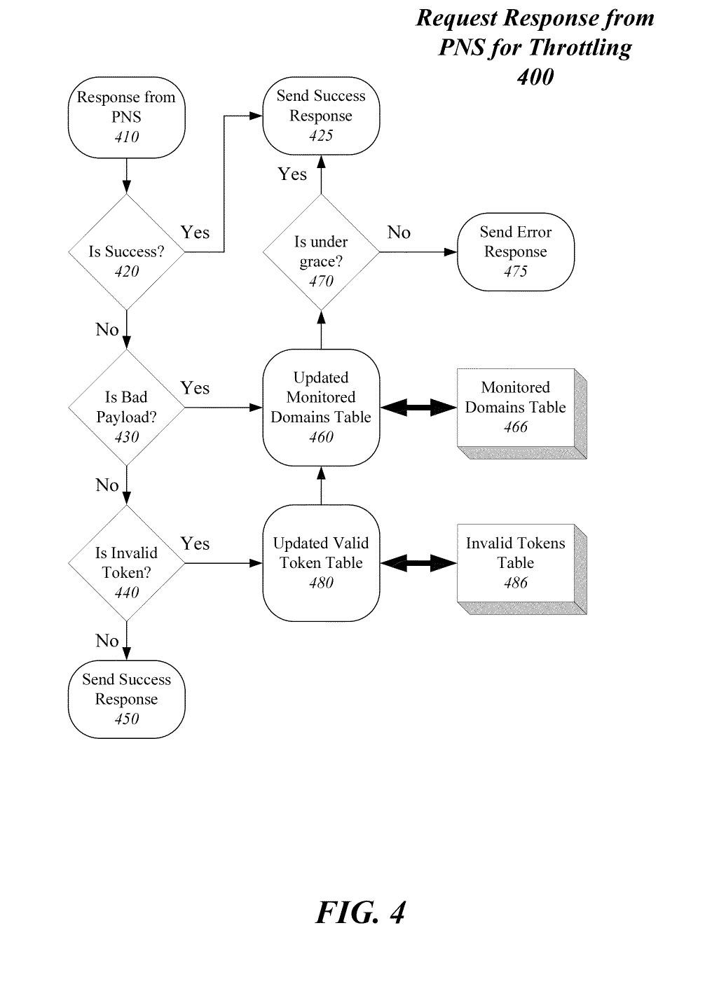

FIG. 4 illustrates one embodiment of a logic flow 400 for processing a response from a PNS for throttling utilizing PNCH component 230 shown in the system of FIG. 2. The logic flow 400 may be representative of some or all of the operations executed by one or more embodiments described herein. In the illustrated embodiment shown in FIG. 4, a response is received from PNS at block 410. A determination is made at block 420 whether or not the response is successful. If the response is successful, then the logic flow proceeds to block 425 where a response such as response 400, is sent. If it is not successful, then a determination is made whether or not the payload is “bad” at block 430. If the payload is not “bad”, then a determination is made whether or not the token is invalid at block 440. If the token is not invalid, then a response such as, for example, response 200 is sent at block 450.

If the determination at block 430 indicates that the payload is bad, then the logic flow proceeds to block 460 where the monitored domains table 466 is updated. In addition, a determination is made at block 470 whether the domain is under the grace period. If the domain is under the grace period then a response is sent at block 425 as described above. If the domain is not under the grace period, then a different response such as, for example response 400, is sent at block 475. If the determination is made at block 440 that the token is invalid, then the logic flow proceeds to block 480 where the invalid tokens table 486 is updated. In addition, the monitored domains table is updated at block 460 with the identity of the offending domain. In this manner, the present invention utilizes the PNCH to prevent harmful attacks to a push notification service (MPNS, APNS).

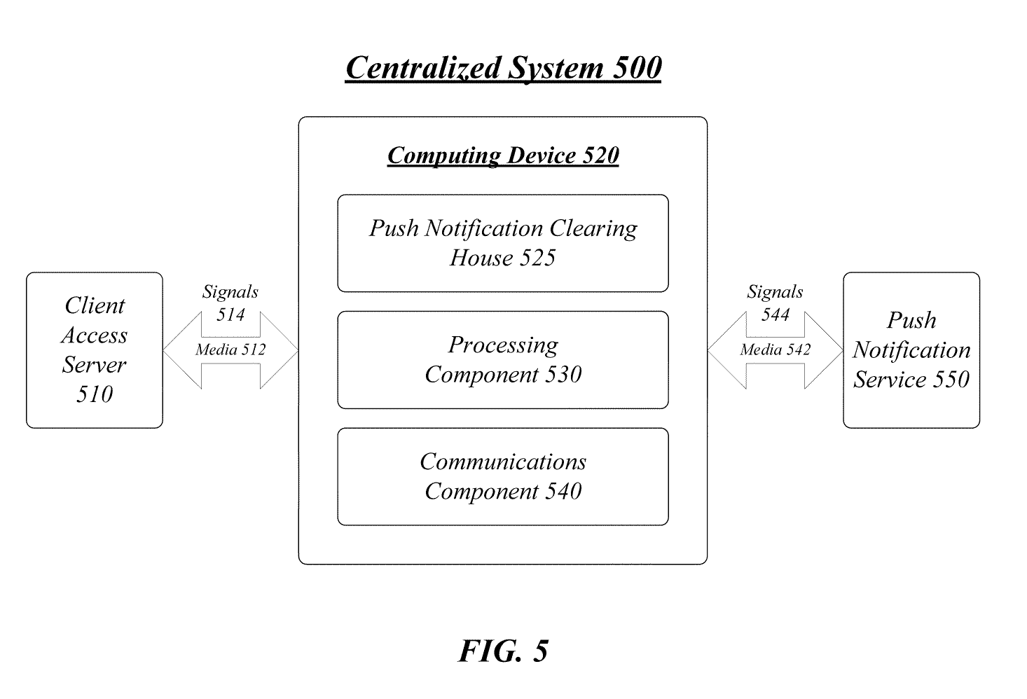

FIG. 5 illustrates a block diagram of a centralized system 500. The centralized system 500 may implement some or all of the structure and/or operations for the push notification clearing house 525 in a single computing entity, such as entirely within a single device 520. The push notification clearing house 525 may correspond to the push notification clearing house 110 described with reference to FIG. 1 and the PNCH component 230 described with reference to FIG. 2.

The device 520 may comprise any electronic device capable of receiving, processing, and sending information for the push notification clearing house 525. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 520 may execute processing operations or logic for the push notification clearing house 525 using a processing component 530. The processing component 530 may comprise various hardware elements, software elements, or a combination of both. Examples of hardware elements may include logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 520 may execute communications operations or logic for the push notification clearing house 525 using communications component 540. The communications component 540 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 540 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 512, 542 may include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The device 520 may communicate with client access server 510 and push notification service 550 over a communications media 512, 542, respectively, using communications signals 514, 544, respectively, via the communications component 540.

Client access server 510 may correspond to the client access server 150 described with reference to FIG. 1. As such, signals 514 sent over media 512 may correspond to the forwarding of request 105 from the client access server 150 to the push notification clearing house 110 for client 155-1. Alternatively or additionally, signals 514 sent over media 512 may correspond to the sending of error messages such as, for example, message 170 from the push notification clearing house 110 to the client access server 150. Similarly and simultaneously, client access server 510 may correspond to the UCWA 220 described with reference to FIG. 2. As such, signals 514 sent over media 512 may correspond to the forwarding of a request such as, for example, request 105 (shown n FIG. 1) from the UCWA 220 to the PNCH component 230. Alternatively or additionally, signals 514 sent over media 512 may correspond to the sending of an error message from the PNCH component 230 to the UCWA 220.

Push notification service 550 may correspond to the push notification service 160 described with reference to FIG. 1. As such, signals 544 sent over media 542 may correspond to the forwarding of a request, such as request 105 from the push notification clearing house 110 to the push notification service 160. Alternatively or additionally, signals 544 sent over media 542 may correspond to the sending of an error report or other message from the push notifications service 160 to the push notification clearing house 110. Similarly and simultaneously, push notification service 550 may correspond to one of the MPNS 240 and APNS 250 described with reference to FIG. 2. As such, signals 544 sent over media 542 may correspond to the forwarding of a request from the PNCH component 230 to the MPNS 240 or the APNS 250. Alternatively or additionally, signals 544 sent over media 542 may correspond to the sending of an error report or other message from the MPNS 240 or the APNS 250 to the PNCH component 230.

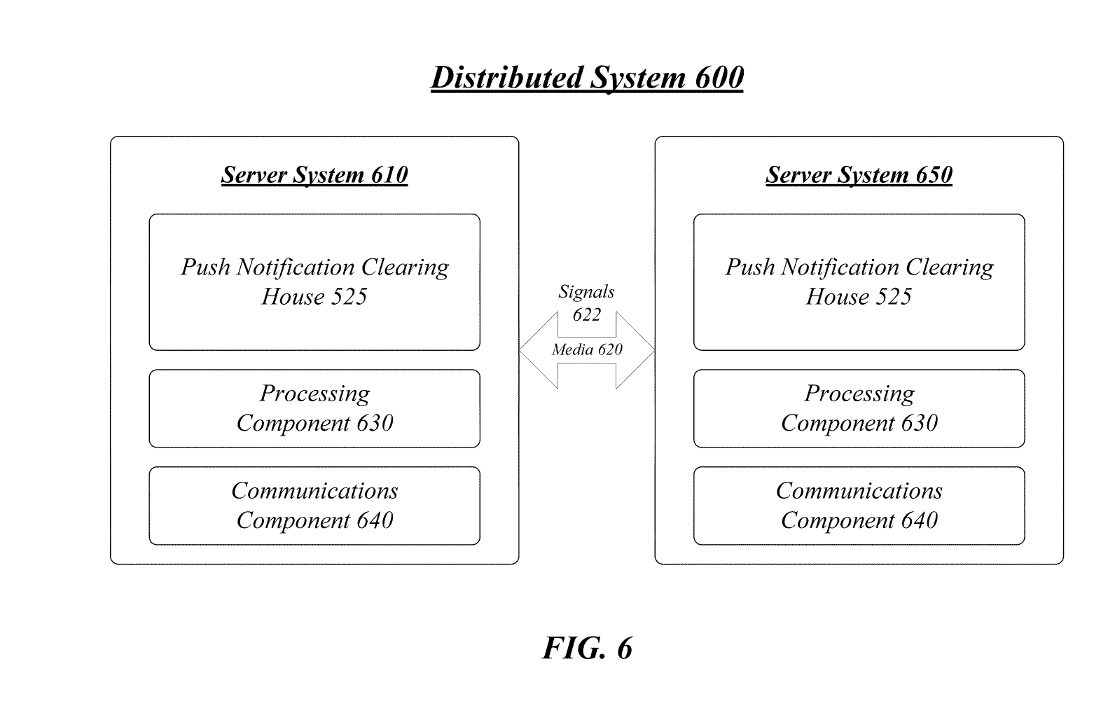

FIG. 6 illustrates a block diagram of a distributed system 600. The distributed system 600 may distribute portions of the structure and/or operations for the push notification clearing house 525 across multiple computing entities. Examples of distributed system 600 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context. The push notification clearing house 525 may correspond to the push notification clearing house 110 described with reference to FIG. 1 and the PNCH component 230 described with reference to FIG. 2.

The distributed system 600 may comprise server system 610 and server system 650. In general, the server system 610 and the server system 650 may be the same or similar to the device 520 as described with reference to FIG. 5. For instance, the server system 610 and the server system 650 may each comprise a processing component 630 and a communications component 640 which may be the same or similar to the processing component 530 and the communications component 540, respectively, as described with reference to FIG. 5. In another example, the systems 610, 650 may communicate over a communications media 612 using communications signals 614 via the communications components 640.

The server system 610 may comprise or employ one or more programs that operate to perform various methodologies in accordance with the described embodiments. Similarly, the server system 650 may comprise or employ one or more server programs that operate to perform various methodologies in accordance with the described embodiments. In various embodiments, portions of the push notification clearing house 525 may be implemented in a distributed fashion across the server system 610 and the server system 650. For example, in one embodiment, the server system 610 may handle the reception and validation of incoming requests from the various clients of the push notification clearing house 525, and handle the transmission of error messages and other responses and messages to the clients of the push notification clearing house 525. In one embodiment, the server system 650 may handle the transmission of outgoing requests to the push notification services, and handle the reception of error messages and other responses and messages from the push notification services.

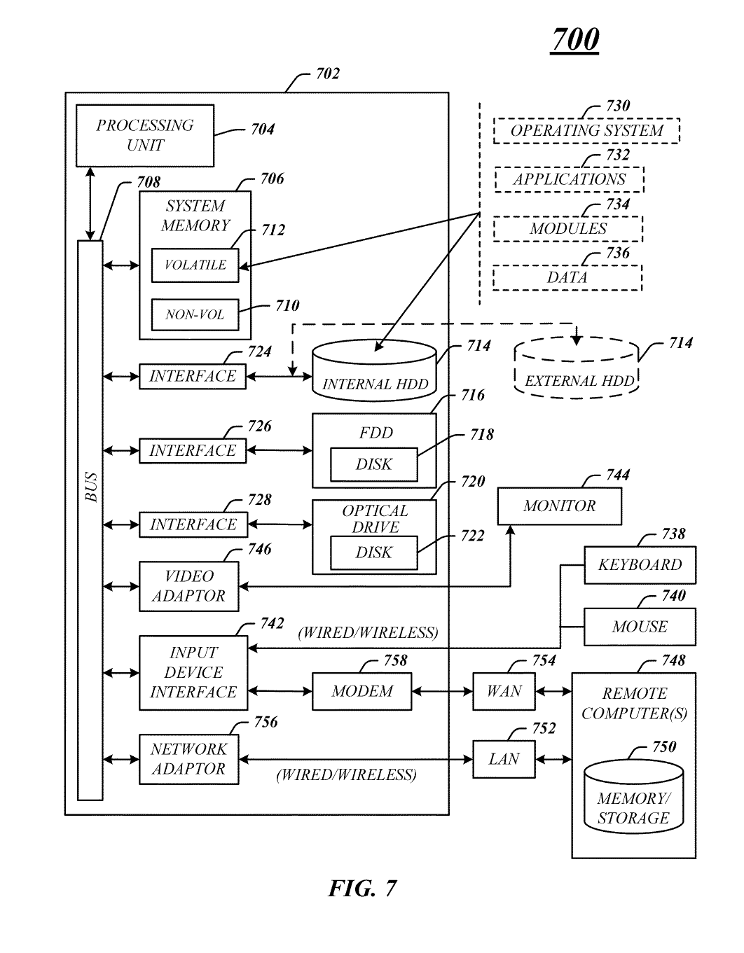

FIG. 7 illustrates an embodiment of an exemplary computing architecture 700 suitable for implementing various embodiments as previously described. In one embodiment, the computing architecture 700 may comprise or be implemented as part of an electronic device. Examples of an electronic device may include those described with reference to FIG. 5 and FIG. 6, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 704.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

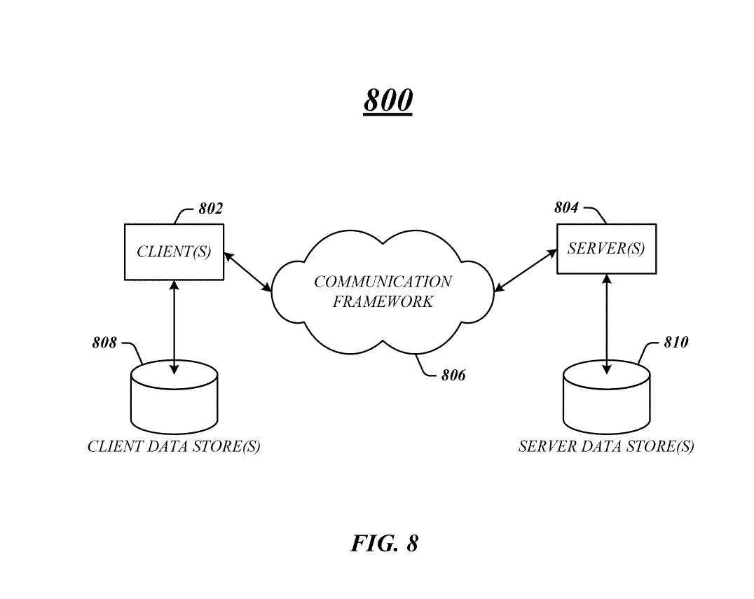

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 comprises includes one or more clients 802 and servers 804. The clients 802 may implement the clients 155-n or any of the clients hosted in any of the domains 140-m or the mobile clients 215. The servers 804 may implement the centralized system 500 or decentralized system 600. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques and protocols. The communications framework 806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor; and
a memory communicatively coupled to the processor, the memory to store an application, the application maintaining an identity of a domain in a monitored domain table and in an offending domain table, the application operative to receive an incoming request from a client in a domain to detect harmful activity based on the request, and to respond to the harmful activity based on the identity of the domain stored in one or both of the monitored domain table and the offending domain table.

2. The apparatus of claim 1, the application operative to determine if the identity of the domain is not stored in the monitored domain table, to add the identity of the domain domain to the monitored domain table, and to send an error message to the domain communicating the detected harmful activity.

3. The apparatus of claim 1, the application operative to determine if the identity of the domain is stored in the monitored domain table, to determine that a grace period is active for the domain, and to send an error message to the domain communicating the detected harmful activity.

4. The apparatus of claim 1, the application operative to determine if the identity of the domain is stored in the monitored domain table, to determine that a grace period has expired for the domain, to increment an offense count for the domain entry in the monitored domain table, to determine that the offense count for the domain entry is under a threshold, and to send an error message to the domain communicating the detected harmful activity.

5. The apparatus of claim 1, the application operative to determine if the identity of the domain is stored in the monitored domain table, to determine that a grace period has expired for the domain identified in the monitored domain table, to increment an offense count for a domain entry corresponding to the identity of the domain in the monitored domain table, to determine that the incremented offense count for the domain entry is at least equal to a threshold, to remove the domain entry from the monitored domain table, to add an offending domain entry for the domain to the offending domain table, and to send an error message to the domain communicating the detected harmful activity.

6. The apparatus of claim 5 wherein the application operative to raise an alert indicating that the domain has been identified as an offending domain.

7. The apparatus of claim 1 wherein the harmful activity comprising one or more of a request queue for the application being full, the request being improperly formatted, the request having a bad payload, and the request having an invalid token.

8. The apparatus of claim 1, the application operative to throttle requests received from domains identified in the offending domain table.

9. A computer-implement method, comprising:
maintaining a monitored domain table;
maintaining an offending domain table;
receiving an incoming request from a client in a domain;
detecting harmful activity based on the incoming request; and
responding to the harmful activity based on an identity of the domain in one or both of the monitored domain table and the offending domain table.

10. The computer-implemented method of claim 9, further comprising:
determining that the domain does not have a domain entry in the monitored domain table;
adding a domain entry corresponding to the domain to the monitored domain table; and
sending an error message to the domain communicating the detected harmful activity.

11. The computer-implemented method of claim 9, further comprising:
determining the domain has a domain entry in the monitored domain table;
determining that a grace period is active for the domain; and
sending an error message to the domain communicating the detected harmful activity.

12. The computer-implemented method of claim 9, further comprising:
determining that the domain has a domain entry in the monitored domain table;
determining that a grace period has expired for the domain;
incrementing an offense count for the domain entry in the monitored domain table;
determining that the offense count for the domain entry is under a threshold; and
sending an error message to the domain communicating the detected harmful activity.

13. The computer-implemented method of claim 9, further comprising:
determining that the domain has a domain entry in the monitored domain table;
determining that a grace period has expired for the domain;
incrementing an offense count for the domain entry in the monitored domain table;
determining that the incremented offense count for the domain entry is at least equal to a threshold;
removing the domain entry from the monitored domain table;
adding an offending domain entry for the domain to the offending domain table;
sending an error message to the domain communicating the detected harmful activity; and
raising an alert indicating that the domain has been identified as an offending domain.

14. The computer-implemented method of claim 9, harmful activity comprising one or more of a request queue for the application being full, the request being improperly formatted, the request having a bad payload, and the request having an invalid token.

15. At least one computer-readable storage medium comprising instructions that, when executed, cause a system to:
receive an incoming request from a client in a domain;
detect harmful activity based on the request, wherein the harmful activity comprising one or more of a request queue for the application being full, the request being improperly formatted, the request having a bad payload, and the request having an invalid token; and
respond to the harmful activity based on one or both of the monitored domain table and the offending domain table.

16. The computer-readable storage medium of claim 15, comprising instructions that when executed cause the system to:
maintain a monitored domain table;
maintain an offending domain table;
determine the domain does not have a domain entry in the monitored domain table;
add a domain entry for the domain to the monitored domain table; and
send an error message to the domain communicating the detected harmful activity.

17. The computer-readable storage medium of claim 16, comprising instructions that when executed cause the system to:
determine the domain has a domain entry in the monitored domain table;
determine that a grace period is active for the domain; and
send an error message to the domain communicating the detected harmful activity.

18. The computer-readable storage medium of claim 16, comprising instructions that when executed cause the system to:
determine that the domain has a domain entry in the monitored domain table;
determine that a grace period has expired for the domain;
increment an offense count for the domain entry in the monitored domain table;
determine that the offense count for the domain entry is under a threshold; and
send an error message to the domain communicating the detected harmful activity.

19. The computer-readable storage medium of claim 16, comprising instructions that when executed cause the system to:
determine that the domain has a domain entry in the monitored domain table;
determine that a grace period has expired for the domain;
increment an offense count for the domain entry in the monitored domain table;
determine that the incremented offense count for the domain entry is at least equal to a threshold;
remove the domain entry from the monitored domain table;
add an offending domain entry for the domain to the offending domain table; and
send an error message to the domain communicating the detected harmful activity.

20. The computer-readable storage medium of claim 19, comprising instructions that when executed cause the system to:
raise an alert indicating that the domain has been identified as an offending domain.
